(19) United States
(12) Patent Application Publication
(10) Pub. No.: US 2013/0063408 A1
(43) Pub. Date: Mar. 14, 2013

(54) PROJECTION DEVICE, WHICH COMPRISES A PROJECTOR, A PROJECTION SURFACE, AND A DATA PROCESSING SYSTEM, AND METHOD FOR OPERATING SAID PROJECTION DEVICE

(71) Applicant: Robert Koppe, Linz (AT)

(72) Inventor: Robert Koppe, Linz (AT)

(73) Assignee: ISIQIRI INTERFACE TECHNOLOGIES GMBH, Hagenberg (AT)

(21) Appl. No.: 13/699,456

(22) PCT Filed: May 20, 2011
(86) PCT No.: PCT/AT11/00234

§ 371 Date: Nov. 21, 2012

(30) Foreign Application Priority Data
May 21, 2010 (AT) A 843/2010

(51) Int. Cl. G09G 5/10

(52) U.S. Cl. CPC G09G 5/10
USPC 345/207

(57) ABSTRACT

A projection device and to a method for operating the device. The projection device includes a projector, a projection surface, and a data processing system, wherein information about the image on the projection surface is transferred to the data processing system and wherein the data processing system controls the projector. The projection surface is designed as a planar optical waveguide, in which photoluminescent particles are integrated and on which a plurality of photoelectric sensors are attached, which are able to couple light out of the waveguide mode and to thereby generate an electrical signal, the strength of which depends on the intensity of the light coupled out at the photodetector.

The invention relates to a projection device comprising a projector, a projection surface and a data processing system, and to a method for operating said projection device.

The image emitted by a projector is represented in an undistorted fashion on a planar projection surface, such as a screen, for example, only when the plane of the projection surface is arranged in the correct angular position relative to the projector, namely parallel to the (imaginary) imaging plane. If this appropriate relative position is not provided, so-called trapezoidal image distortion arises, in which a rectangle is imaged as a trapezoid if the imaging plane and the plane of the projection surface are rotated relative to one another exclusively about a straight line parallel to one side of a rectangle. In the case of the simpler projectors from among the projectors which are commercially available nowadays, this distortion can then be corrected simply if the imaging plane and the plane of the projection surface are rotated relative to one another exclusively about a horizontal axis. With the aid of keys for so-called “keystone correction” or “trapezoidal correction”, the upper image region is compressed or expanded in terms of its horizontal extent relative to the lower image region. The appropriate keys are pressed by an operator, who assesses the quality of the projected image, until the image is suitable in the opinion of said operator.

In the projector, the image is compressed or expanded usually by mechanical adjustment of the position of an optical unit such as typically a mirror, as a result of which the imaging plane is aligned parallel to the plane of the projection surface. In the case of images present as digital information, the digital “original” image original can also be converted into a distorted projection image original which then brings about a correct image again precisely as a result of the distorting projection on the projection surface.

Alongside the manual trapezoidal image distortion correction described, there are, of course, also corrections that proceed automatically.

The documents US 2005213081 A1, WO 2005006073 A2, EP 1654515 B1, EP 1395050 B1 and US 2005190343 A1 describe in this respect a principle according to which a projector is provided with optical distance measuring units and a computing unit. Automatically the distance of at least three points at a distance from one another on a projection surface assumed to be planar is measured, the position and distance of the projection surface relative to the projector are calculated therefrom and in further consequence the optical system or the image to be projected is correspondingly adapted. For determining the points on the projection surface, a test image is usually projected onto the projection surface.

WO 2006024254 A1 describes a method and a device with the aid of which an image projected onto a surface appears to be at least largely correct in terms of color and geometrically for at least one observer, even if said surface is neither planar nor of one color. By means of the projector, onto the surface a projection image original appropriately distorted and altered locally in color relative to the original image is emitted onto the surface, such that the correct image becomes visible again from the standpoint of the observer with viewing direction onto the surface. The rules for converting an original image present as digital information into a distorted projection image original modified in color are found by virtue of the fact that the projector emits known test images to the surface, the images produced on the surface are recorded by a camera fitted as much as possible exactly at the location of the observer and, from the local displacements of pixels relative to the desired position, which displacements can be ascertained upon evaluation of the image, and from the color deviations relative to the correct color which occur at individual locations of the projection surface, a rule is calculated for each image pixel as to how the latter is to be locally displaced relative to the arrangement on the original image in order to form the projection image original and how its color is to be altered relative to the color on the original image. A controlling data processing system can thus accurately identify and also influence to which point on the projection surface a projector transmits which pixel. Therefore, the system is also readily applicable to the projection of a plurality of projectors onto a common large projection surface. However, the system is complex in terms of hardware and software. Interactivity to the effect that the projection surface is illuminated by users by means of light pointers and a program in a central data processing system is controlled in a manner dependent thereon can thus scarcely be supported.

The object on which the invention is based is to simplify the coordination between projector and projection surface in terms of hardware and software and to better support interactive applications.

In order to achieve the object, what is taken as a basis is a projection device comprising at least one projector, a projection surface and a data processing system, wherein information about the image on the projection surface is passed to the data processing system and wherein the data processing system controls the projector.

The invention provides for the projection surface to be embodied as a planar optical waveguide in which photoluminescent particles are integrated and to which a plurality of photoelectric sensors—designated hereinafter as “photodetector” for short—are fitted, which are able to couple out light from the waveguide mode and thereby to generate an electrical signal, the strength of which is dependent on the intensity of the light coupled out at the photodetector. The signal is transmitted to the data processing system. The latter can identify how strong the signal is and from which photodetector it originates. For the purpose of calibration between projector and projection surface, by means of the projector one or a plurality of geometrically simple and clear images are emitted onto the projection surface, which bring about electrical signals at the individual photodetectors, from which signals the data processing system in turn deduces the position of individual points of the projected image on the projection surface.

The invention is explained in greater detail with reference to drawings:

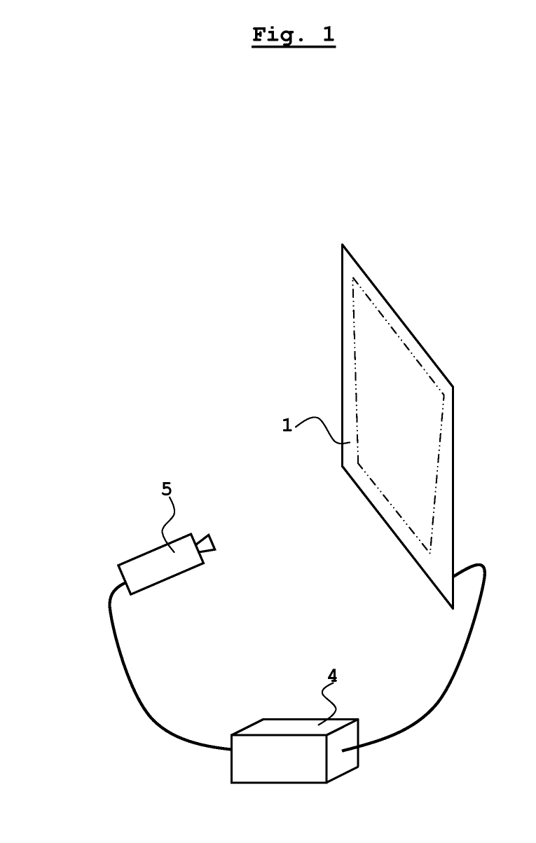

FIG. 1: shows a basic schematic diagram regarding the essential elements of the projection device according to the invention.

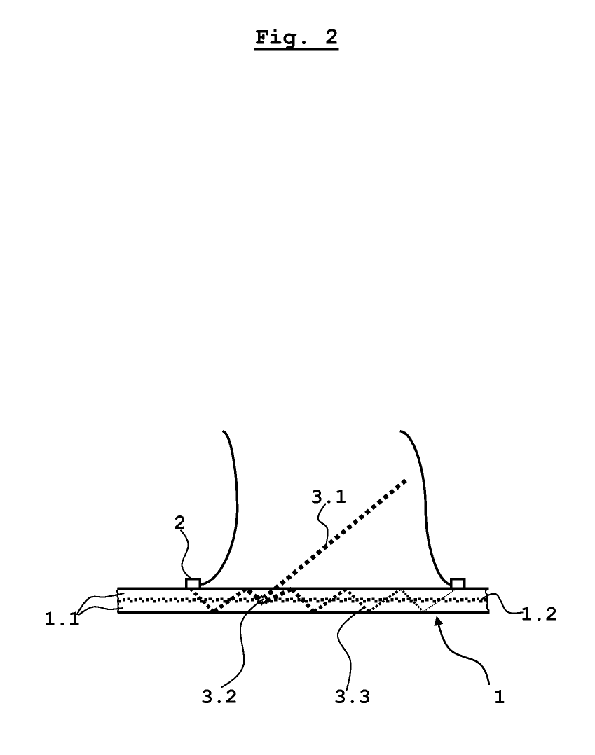

FIG. 2: shows essential elements of the projection surface in a sectional view that is not to scale. Light beams are represented in a symbolized manner by dotted lines.

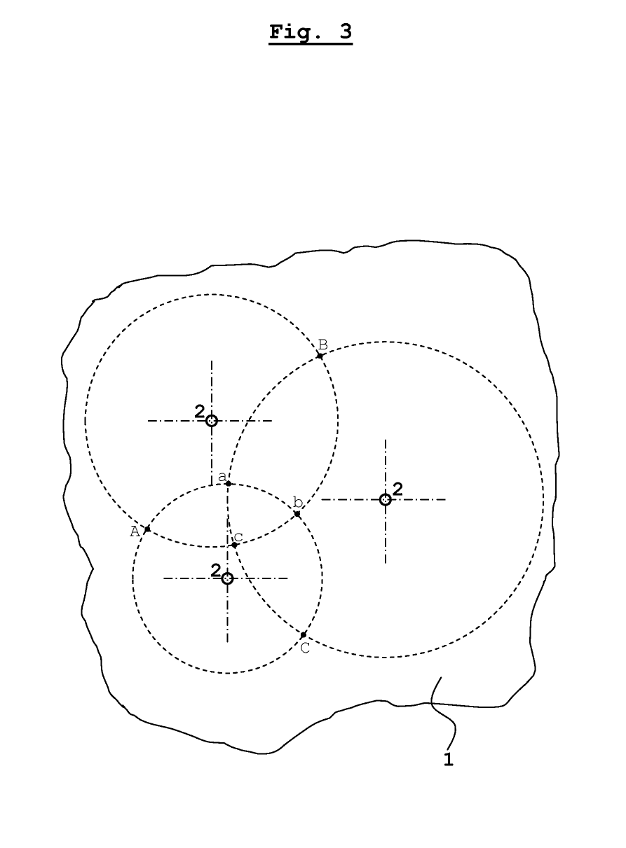

FIG. 3: is a frontal view of an excerpt from a projection surface according to the invention.

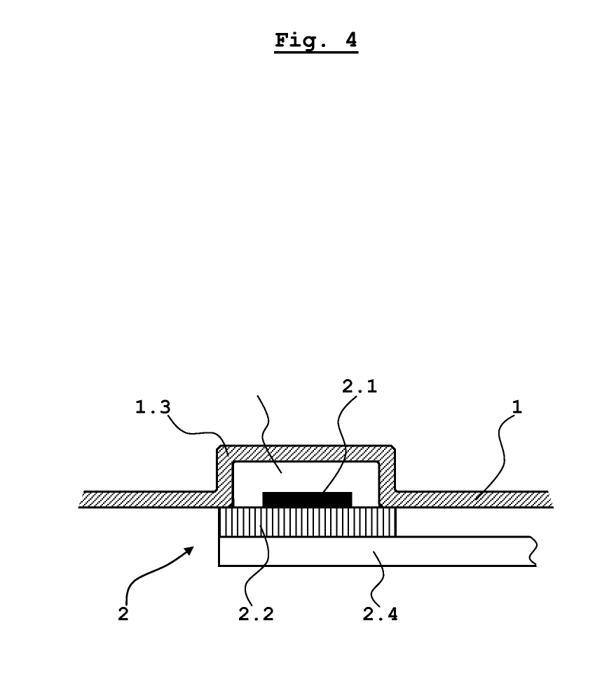

FIG. 4: is a partial sectional view of an excerpt from a projection surface embodied in a particularly advantageous fashion.

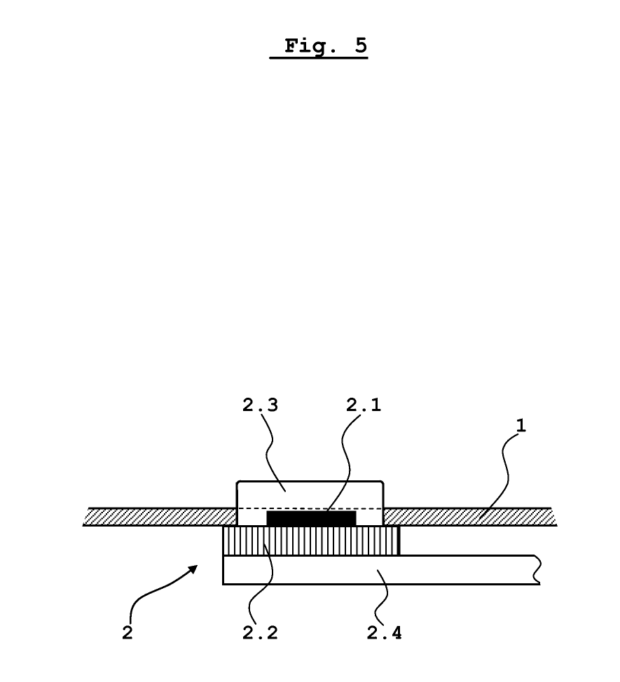

FIG. 5: is a partial sectional view of an excerpt from a further projection surface embodied in an advantageous fashion.

In accordance with FIG. 1, the essential basic elements of a projection device according to the invention are a projector 5, a projection surface 1 and a data processing system 4.

For the purpose of representing an image, the projector 5 emits light onto the projection surface 1. In the example illustrated, the image is a closed polygon composed of dash-dotted lines. On the projection surface, electrical signals are generated at photodetectors (illustrated in FIG. 2 to FIG. 5) in a manner dependent on the light impinging on the projection surface and are passed to the data processing system 4. For its part, the data processing system 4 controls the projector 5 and also supplies it with image data.

The calibration between projector 5 and projection surface 1 can proceed for example in accordance with the following sequences:
The projector 5 uniformly illuminates the entire area that can be reached by it on the projection surface 1, for example white. The photodetectors fitted to the projection surface accordingly detect light. At the edge of the illuminated region of the projection surface, light is also guided by luminescence wave guiding to photodetectors outside the illuminated zone. From different measured light intensities between adjacent photodetectors and from the ratio of said light intensities, it is possible for the data processing system to identify, by data evaluation, between which adjacent photodetectors the edge of the illuminated region runs and how near it is to the individual photodiodes. The projector can thereupon be driven by the data processing such that, in the case of a projection surface arranged in planar fashion, a trapezoidal correction is effected, that is to say that the image emitted by the projector with a rectangular edge brings about an image with a rectangular edge having the same aspect ratio on the projection surface.
As already discussed with regard to the prior art, this adaptation of the projector can be effected by appropriate displacement of optical components, such as typically a mirror, or by an appropriately distorted image being communicated as a projection original to the projector. In that case “appropriately distorted” means distorted complementarily to how images are distorted during the projection by the projector onto the projection surface.
The projector 5 projects a simple pattern, for example a few white stripes, onto the projection surface 1. From the measured position of individual points of said stripes on the projection surface, for example of end points or intersection points, it is possible to calculate the geometrical relationship between original image and image on the projection surface, such that the required geometrical distortions between an original image and a projection original to be emitted by the projector can be calculated in order that an original image is represented as far as possible in an appropriate fashion, for example correctly in terms of area and/or angularly correctly on the projection surface, which need not necessarily be embodied in a planar fashion.
On the basis of the electrical signal strength brought about at the individual photodetectors and the known emitted light intensity, it is also possible to calculate the translation factor of the individual photodetectors between light intensity emitted by the projector and electrical signal strength.
With very simple mathematical effort and simple algorithms but with some expenditure of time for projection and measurement, it is possible to create a table as to how the individual pixels of an original image to be represented are to be displaced with respect to a projection original which is distorted by comparison therewith and which is to be emitted by the projector, by temporally successively only individual light spots being emitted by the projector and their position on the projection surface being measured.

Since the projection surface can also be present in the curved form, for instance as semicylinders for panoramic projections, it is also possible to perform such a correction of the projected image by the projected image being distorted such that it is distributed uniformly over the area.

The images of a plurality of projectors which overlap in the edge regions can likewise be adapted to one another such that a large seamless image arises. This is done by a calibration of the individual images as described above with subsequent adaptation of the brightness of the overlapping image edges, thus resulting in a fluid transition of the projected images.

By means of the signal strength of the photodetectors, the absolute light intensity of the individual projected images can also be deduced, such that the brightness of the projectors can be adapted such that a combined image can have a uniform brightness.

After the calibration between projector and projection surface, the device is extremely well suited to interactive operation with the aid of light pointers, typically laser pointers. Since the data processing system receives information about which area region of the projection surface is assigned to which image region of the original image and since the projector also actually represents very reliably and accurately on the relevant area region of the projection surface the image part appropriate therefor, the position of the light spot brought about by a luminous pointer on the projection surface, which light spot can be ascertained by means of the photodetectors of the projection surface, always corresponds appropriately to the represented image like a cursor on a computer screen, and so the data processing system 4 can therefore be controlled well thereby.

Since projection surfaces are usually viewed by an audience of several to many people, one advantageous application of the projection device according to the invention resides in approving a plurality of luminous pointers and correspondingly equipping the individual persons of the audience each with a pointing device.

By way of example, votes among the persons of the audience can then be carried out. For this purpose, the individual persons use the luminous pointers to illuminate, for example, a left or right selection field represented on the projection surface. The light intensity measured on a selection field is proportional to the number of light pointers pointing thereto. Depending on the selection field at which the most light pointers are measured and thus depending on the majority of the votes, it is possible, for example, to continue a presentation to different contents.

If there are changes in brightness in the room in which the projection surface is situated, the signal strengths of all the photodetectors of the projection surface change without this being synchronous with a change in the projected image content. Changes in brightness in the room, for example if the light is switched on or off or if blinds are opened or closed, can therefore readily be discerned by the data processing system by means of the evaluation of the signals from the photodetectors of the projection surface. Advantageously, the brightness of the projector or of the room light is appropriately readjusted by the data processing system in adaptation to these findings. (In other words, the light intensity of the projector is set to be lower in a darkened room and the light intensity of the projector is set to be higher if there is higher brightness in the room, or the illumination of the room is readjusted in accordance with the requirements of a certain projection quality.)

For handling and cost reasons, it is advantageous for the projection surface 1 to be embodied as a flexible film. For this purpose, the planar optical waveguide, the construction of which is depicted schematically in FIG. 2, and which forms the essential part of the projection surface 1, is advantageously formed from a transparent polymer having a layer thickness of 20 to 500 μm.

Within the meaning of this document, the term “transparent polymer” is also taken to mean and encompasses “transparent polymer mixtures”.

In one particularly preferred embodiment, photodetectors 2 are arranged on the projection surface in each case in a recess of the optical waveguide, which is formed by a deforming method such as thermoforming or embossing in the otherwise planar film. As a result, the projection surface is particularly thin, robust and flexible.

For the correct function of the projection surface 1, it is important that the photodetectors 2 are fitted not or not only to its surface edge, but primarily also to surface regions situated at a distance from all edges.

The planar optical waveguide, the construction of which is depicted schematically in FIG. 2, and which constitutes the most essential part of the projection surface 1, consists, for example, of two approximately 0.1 mm thick cover layers 1.1 composed of PET, between which an approximately 0.001 mm thick layer 1.2 composed of a homogeneous mixture of the plastic polyvinyl alcohol and the dye Rhodamine 6G is laminated. The layer 1.2 is photoluminescent. It is thick enough that its absorption for light impinging thereon normally and having a wavelength of 532 nm is above 80%. (The layer thickness required for this purpose can best be determined by an experiment.)

If a light beam 3.1 with an appropriate spectrum impinges on the layer 1.2, then it triggers photoluminescence at the dye particles of the layer 1.2. Diffusely scattered light having a longer wavelength arises in this case. In accordance with the known underlying functional principle of light wave guiding, it propagates in the transparent layers 1.1 and substantially also remains in these layers, the it is reflected back into the material of the layers 1.1 at the interfaces with the surroundings (air) on account of the different refractive index.

For example, in a square grid having a period length of 5 cm, photodetectors 2 which occupy a cross-sectional area of approximately 2×2 mm² are fitted to the exposed side of one of the two PET layers 1.2 such that they couple out light from the PET layer and couple it in at their pn junction. The signals of all the photodiodes 2 are fed via electrical lines 5 and a frequency filter 6 to a data processing system 7, in which they are measured and processed.

The intensity of the light 3.3 generated in the optical waveguide at the impinging light spot 3.2 as a result of photoluminescence decreases with increasing distance from the light spot 3.2. For geometrical reasons, the intensity decreases proportionally to the reciprocal of the distance. A further, exponential decrease in the intensity occurs because the light guiding in the waveguide is beset by losses.

The intensity of the light 3.3 in the waveguide depending on the distance r relative to a point of impingement of a light spot 3.2, that is to say relative to the point at which the luminescence takes place, can thus be described by the following formula:

I=I₀*exp(−k.r)/r

In this case, k is a material parameter and the initial intensity I₀ is dependent on the energy of the light beam 3.1 introduced.

Therefore, the strength of the electrical signal generated at the individual photodetectors on account of detected light is also dependent on the distance between the individual photodetectors and the point of impingement of a light spot 3.2.

If a plurality of photodetectors are connected to a planar optical waveguide, then different intensities of the light in the waveguide mode are measured at them, the measurement results being dependent on how far away the measuring photodetector is from the point of impingement of the light spot generating the luminescence. From the ratio of the measured signal strengths at the individual photodetectors, the more precise impingement position of the light beam that triggers the luminescence on the projection surface can be deduced by means of mathematical methods which can be automated in terms of data technology.

FIG. 3 serves to illustrate an algorithm which is suitable for this purpose, and which is roughly outlined schematically below: Assuming an initial intensity I₀ which is identical for all of the photodetectors considered, depending on the results measured at the individual photodetectors with respect to the individual photodetectors it is possible to calculate on what circular line all around the relevant photodetector the point of impingement of the light spot to be localized would have to lie. The corresponding circles of three photodetectors are depicted by way of example using dashed lines in FIG. 2. The circles have a total of six intersection points A, B, C, a, b, c.

For the calculation, the initial intensity I₀ valid for all three photodetectors is now increased or decreased until the three inner intersection points a, b, c in accordance with FIG. 2 coincide at a single intersection point. The center of the impinging light spot lies exactly at this “triple intersection point” thus found.

If the distances between the individual photodetectors are not greater than a few cm, the exponential reduction—caused by loss—of the intensity of the light guided in the waveguide is insignificant relative to the geometrically governed reduction of the intensity. The abovementioned formula can then be approximated sufficiently well by the formula

I=I₀/r

Thus, the calculation can be simplified and the algorithm described can be iterated more rapidly.

At the operating speed of the data processing systems which are obtainable nowadays in great numbers without any problems and cost-effectively, however, even the more exact calculation in accordance with the first-mentioned formula is possible in such a fast time that the perception of a real-time measurement is given with regard to the rapidity of ascertaining the location of an impinging light spot.

Depending on area and required resolution, as many photodetectors as desired, preferably in a regular pattern, can be mounted on the projection surface.

The more densely the photodetectors are mounted, the greater the minimum signal strength and accordingly the resolution of the component with the same read-out electronics. In experiments with an optimized waveguide on the basis of a plastic slab doped with dyes, it was possible to achieve an accuracy of better than +/−1 mm for a spacing of the photodetectors of 12 cm in a square pattern.

For mounting the photodetectors on the optical waveguide, an adhesive should be used which, in the cured state, produces a good optical contact between waveguide and photodetector. The “good optical contact” is produced when the cured adhesive is transparent to the light in the waveguide mode and when its refractive index is between the refractive index of the waveguide 1 (that is to say of the layer 1.1) and the refractive index in the adjacent part of the photodetector. (The smaller the difference between the refractive indices of adjacent materials, the better light is guided through the boundary layer between the two materials.)

FIG. 4 illustrates a typical construction of a photodetector 2 and an advantageous arrangement on an optical waveguide 1.

The photodetector 2 consists of a photoelectric element 2.1, typically a piece of silicon wafer, which, as seen electrically, constitutes a photodiode or a phototransistor. One side of said element 2.1 is connected to one side of a typically ceramic base lamina 2.2 and electrically contact-connected to electrical conductors arranged there. The electrical contact is led further via electrical lines 2.4 that lead away and are likewise connected to the base lamina 2.2. Said lines can typically be formed by wires or a layer on a flexible circuit board.

The light-sensitive side of the photoelectric element 2.1 is enclosed by a transparent “window” 2.3. This window, which typically consists of a transparent plastic, is connected to the optical waveguide 1 by adhesive bonding.

In the advantageous embodiment illustrated in FIG. 4, a depression 1.3 is embossed into the optical waveguide 1 at the location of adhesive bonding to the photodetector, the inner contour of said depression being identical to the outer contour of the window 2.3. The window 2.3 is inserted into said depression 1.3 and adhesively bonded thereto.

As a result of this geometrical embodiment of the connection surface between the photodetector 2 and the waveguide 1, significant advantages are afforded by comparison with an arrangement of a photodetector on a planar, non-deformed region of the waveguide. The connection is significantly more robust mechanically, the assembly can be handled better, since the photodetector projects less, and the optical connection between waveguide and photodetector is better.

Typically, the cross-sectional dimensions of a window 2.3 of a photodetector 2 in the plane of the waveguide are approximately 2 by 2 mm² and the height perpendicular thereto is in this case approximately 0.5 mm. It has been found that the appropriate depression 1.3 in the waveguide 1 can be produced without any problems by embossing if the waveguide is formed from a polymer having a layer thickness of 20 to 500 μm.

In accordance with FIG. 5, a photodetector 2 can also be fixed to a waveguide 1 by an opening being stamped out at the waveguide, said opening having exactly the cross-sectional contour of the window 2.3 of the photodetector 2, the window being inserted through said opening, and the cut surface of the opening in the waveguide being adhesively bonded to the window 2.3. The arrangement is particularly flat.

It should be mentioned that it is also possible to produce a photodetector by a printing or vapor deposition method directly on the surface of the waveguide.

An adhesive bond between photodetectors 2 and the luminescent film is not absolutely necessary if the luminescent films are roughened at locations close to the photodiodes or are coated with white color at the locations opposite the photodiodes. The light from the waveguide mode is coupled out there and scattered from the film onto the photodetector.

In one advantageous embodiment, the projection surface is covered on the viewer side by a color filter film which does not allow the luminescent light guided by luminescence wave guiding in the projection surface to pass through but does allow passage of light of the luminous pointers and light which is emitted to the projection surface by the projector 5 for the purpose of calibration. As a result, the signal/background ratio at the photodetectors of the projection surface is improved and the projection surface offers a better, more homogeneous color impression for the observers. In an embodiment without such a filter film, luminescence effects on the projection surface are otherwise perceived in the form of disturbing colorful points.

For the ideal representation of the projection, a further film is clamped in front of the previously mentioned films and uniformly backscatters a large part of the incident light of any color and thus enables a clear color and shape impression for the viewer when an image is projected. This film is intended to allow enough light to pass through in order that an interpretation of luminous signals in the sense of the above points is possible.

1. A projection device comprising a projector, a projection surface and a data processing system, wherein information about the light distribution on the projection surface is passed to the data processing system and wherein the data processing system controls the projector, wherein the projection surface is embodied as a planar optical waveguide in which photoluminescent particles are integrated and to which a plurality of photoelectric sensors are fitted, which are able to couple out light from the waveguide mode and thereby to generate an electrical signal, the strength of which is dependent on the intensity of the light coupled out at the photodetector.

2. The projection device as claimed in claim 1, wherein the projection surface is formed as a flexible film composed of a transparent polymer having a layer thickness of 20 to 500 μm.

3. The projection device as claimed in claim 1, wherein photodetectors are arranged at surface regions situated at a distance from all edges.

4. The projection device as claimed in claim 1, wherein photodetectors are arranged in each case in a recess of the projection surface, which is formed by a deforming method such as thermoforming or embossing in the otherwise planar film.

5. The projection device as claimed in claim 1, wherein the projection surface is covered on the viewer side by a color filter film which does not allow the luminescent light guided in the projection surface to pass through.

6. A method for operating a projection device comprising a projector, a projection surface and a data processing system, wherein information about the image on the projection surface is passed to the data processing system and wherein the data processing system controls the projector, wherein the information about the image on the projection surface is transmitted to the data processing system by virtue of the fact that light impinging on the projection surface brings about luminescent light in the projection surface, which luminescent light propagates in the projection surface by light wave guiding and in the process attenuates in terms of its intensity and brings about on photodetectors arranged on the projection surface an electrical signal, the strength of which is dependent on the light intensity and which is passed to the data processing system.

7. The method as claimed in claim 6, wherein, in the case of a projection surface arranged in planar fashion, a trapezoidal correction is effected between projector and projection surface by the projector uniformly illuminating the entire area that can be reached by it on the projection surface, in that, from different measured light intensities between adjacent photodetectors, the data processing system deduces the position of the edge of the illuminated area on the projection surface, and in that the projector is thereupon driven correctively by the data processing.

8. The method as claimed in claim 6, wherein for the purpose of calibration between projector and projection surface by means of the projector a pattern is emitted onto the projection surface, in that the position of individual points of the pattern on the projection surface is detected by measurement, in that the data processing system calculates therefrom the geometrical relationship between original image and image on the projection surface, and in that the data processing system furthermore calculates a specification in accordance with which an original image has to be distorted to form a projection original to be emitted by the projector in order to bring about an undistorted image on the projection surface.

9. The method as claimed in claim 6, wherein by means of the projector a pattern is emitted onto the projection surface, in that the position of individual points of the pattern on the projection surface is detected by measurement and in that for a photodetector on the basis of the electrical signal strength brought about thereat and the known triggering light intensity emitted by the projector, the translation factor of said photodetector between light intensity emitted by the projector and electrical signal strength is calculated.

10. The method as claimed in claim 6, wherein temporally successively only individual light spots are emitted onto the projection surface by the projector, in that the position of the light spots on the projection surface is measured and a table is created therefrom as to how the individual pixels of an original image to be represented are to be displaced with respect to a projection original which is distorted by comparison therewith and which is to be emitted by the projector, in order to bring about an undistorted image on the projection surface.

11. The method as claimed in claim 6, wherein a plurality of projectors illuminate the projection surface and the information of the distortion of each projector is determined and the images of the projectors are subsequently coordinated with one another in terms of brightness and position such that the overall impression of a single, larger image arises.

12. The method as claimed in claim 6, wherein the total luminous intensity of a plurality of luminous pointers is determined by the data processing system by means of the evaluation of the signals from the photodetectors of the projection surface in order to identify how many luminous pointers are pointing onto a certain area region of the projection surface.

13. The method as claimed in claim 6, wherein the data processing system, by means of the evaluation of the signals from the photodetectors of the projection surface, detects such brightness fluctuations in the room in which the projection surface is situated which are independent of the images emitted by the projector, and in that the intensity of the light emitted by the projector is tracked to the brightness thus measured.
